(19) United States
(12) Patent Application Publication
(10) Pub. No.: US 2002/0189591 A1
(43) Pub. Date: Dec. 19, 2002

(54) Fuel injection reduction electronically with optimal control (FIRE-OC)

(76) Inventor: Mark Richard Easton, Tucson, AZ (US)

Correspondence Address: Mark Easton, 4011 N. Camino De Lupo, Tucson, AZ, 85718, US

(21) Appl. No.: 09/843,564

(22) Filed: Apr. 26, 2001

(51) Int. Cl. F02D 7/00

(52) U.S. Cl. 123/481

(57) ABSTRACT

This invention is an automotive device or method used to disable fuel injector(s) on a sequential multi-port fuel injected engine in a modulated fashion. The modulation provides an equal average load to all cylinders. This technique improves fuel economy when properly compensated for the additional air proportion. Electronic control enables reserve power when needed by returning to normal operation. Also a device to reduce typical acceleration is presented.

### BACKGROUND OF THE INVENTION

This invention relates generally to an automotive device to increase fuel economy. The first method uses vehicle acceleration limits to improve economy. The second method disables fuel injector(s) on a sequential multi-port fuel injected engine in an optimal fashion. More particularly this method relates to an improved method that does not modify the valve operation and improves fuel economy.

### BRIEF SUMMARY OF THE INVENTION

The automotive industry has used various methods to improve fuel economy throughout the years (such as dual displacement). The advent of fuel injection lends itself to electronic control. In the past combinations of electronic and mechanical control is used in combination to improve fuel efficiency. This new method does not modify the valve operation in any way. Mechanically controlling valve operation has been plagued with reliability issues and complicates the operation. There is also a variable displacement engine that is a completely different approach.

### OBJECTS AND ADVANTAGES

Included with this method is an acceleration limit unit that is analogous to a speed governor except limiting acceleration. This device is used to improve fuel economy and will have an automatic override during wide open throttle operation.

There is currently a need for a device, which improve fuel economy and provides sufficient power when there is more demand. Disabling fuel supply of cylinders in multicylinder engines is well known to the art. Accomplishing this without changing valve operation is unprecedented. Maintaining an equal distribution of average load to all of the cylinders is one of the keys to make this feasible. Using fuel flow rate as feedback enables minimum consumption, while maintaining the engine above stall conditions. The reliability is very important and with no moving parts and proper design exclusive electronic control is an improvement to previous methods.

Another advantage is the simplicity since only a modification to the electronic control is needed. There is also an optional addition of a fuel flow sensor for optimal control of the fuel flow rate (economy).

### DRAWINGS AND FIGURES

FIG. 1 shows the throttle conditioning unit used in the Automatic Acceleration Reduction (MR) method.

FIG. 2 shows both MR and the Modulated Fuel Injection (MFI) method used in conjunction.

### List of Reference Numerals in Drawing

1 Throttle, electronic or mechanical converted to electronic

2 Throttle Conditioning Unit (TCU)—With optional user controls for custom response.

3 Fuel flow sensor (optional)

4 Acceleration Modulation Unit—Control to optimize modulation of fuel injectors

5 Speedometer and/or tachometer (stock)

6 Brake sensor (stock)

7 Electronic control unit (stock)—Main electronic engine control

8 Oxygen sensor (stock)

9 Oxygen (sensor) Control Unit—Hardware or software or firmware to modify the O2 sensor input.

10 Electronic switches or control software to disable one or more fuel injectors.

11 Fuel injectors (stock)

### DETAILED DESCRIPTION OF THE INVENTION

Narrative Description and Operation

The improvement of fuel economy by adaptive electronic control will be explained in the following paragraphs. The user at anytime can disable the electronic control for factory settings. There are several levels of control depending on car options.

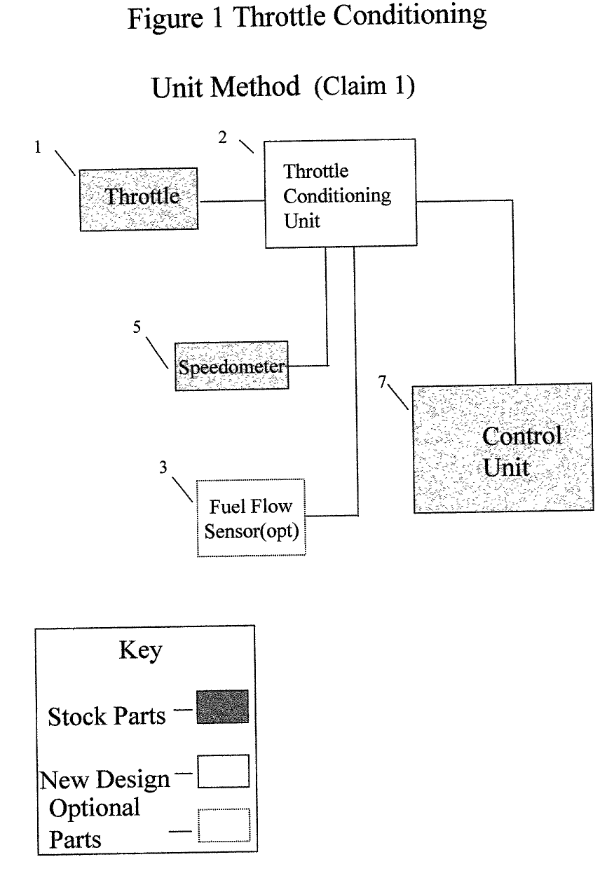

The first method is electronic conditioning of the accelerator to minimize acceleration and maximize fuel economy, and will be referred to as automatic acceleration reduction (AAR FIG. 1). This first method (AAR) is a brute force approach and improves fuel economy over normal operation. The consumer will be informed of the reduced acceleration for the gain in fuel economy There will be at least three levels of economy. The first level is just the stock configuration. The second level (see FIG. 1) will be slightly reduced acceleration and can also have an adjustment to suit the users level of comfort and provide several different accelerator profiles (e.g. logarithmic). This control changes the mapping or of 2 in FIG. 1 and is a function of acceleration. The third level will be designed to maximize fuel economy within a reasonable speed range with a governed speed limit with user selectable limits. An adjustable minimum acceleration control will also be provided. The combinations of profiles possible is endless and the object of block 2 is to improve fuel economy. The full throttle and no throttle endpoints will be the same as the original endpoint throttle setting for safety concerns. An optional fuel flow rate sensor is also shown and this will be used to set limits on fuel consumption similar to the acceleration limits.

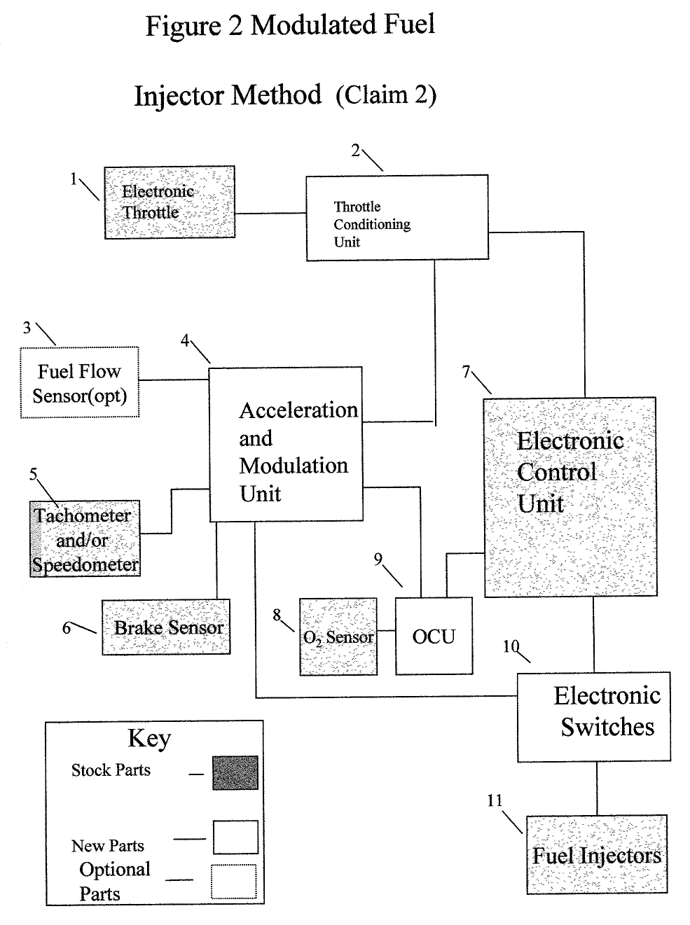

The second method is if the vehicle has sequential multi-port fuel injection, controlling the effective number of pistons while compensating for the exhaust oxygen sensor (FIG. 2). By effective number of pistons, the idea is to turn off different fuel injectors during each engine cycle and alternating different cylinders over several cycles, this will be referred to as modulated fuel injection (MFI). For example on an eight cylinder engine the first cycle you would skip the even numbered cylinders and on the next cycle you would skip the odd cylinders while modifying the exhaust sensor slightly for the missing cylinders (see table 1). By rotating the unused cylinder(s) there will be even distribution of the engine load. As power requirements are decreased more fuel injectors from selected cylinders are disabled for each engine cycle. When turning off cylinders this also allows more oxygen into the hot exhaust for more complete burning of any excess emissions.

There will be several levels of override due to safety concerns, the first being a manual switch and the other will sense wide-open throttle (WOT). The wide open throttle condition will return normal operation of the vehicle for a fixed amount of time roughly thirty seconds.

The second method (MFI) primary inputs will be the accelerator, engine rotation speed (RPM), Oxygen sensor, and brake input (and clutch if appropriate). One example is that with a manual transmission with brakes applied the fuel delivery will be controlled to a near stall condition for a short time, with the fuel injectors turned off. During that short time there will be zero effective cylinders increasing the average mileage while conserving brakes. Then before stalling the minimal fuel delivery will be restored. This is obviously the extreme case but guaranties better mileage.

The modulated fuel injection depends on calibrated exhaust sensor compensation. By this it means that an oxygen conditioning module (OCM see FIG. 1) will feed in the stock input to compensate for more oxygen from the unused cylinders. The idea is to correct the sensor readings to give the right stoichiometric reading. Initial testing without oxygen sensor modification showed no gain or loss and compensation is essential. With less heat and horsepower generated by fewer cylinders the efficiency can be greater with careful control. The cooling capacity is the same therefor the engine will run cooler and second law (of thermodynamics) losses are less. There is some loss in efficiency from compressing the unused cylinders, which is partially regained as the cylinders expand (like a ball bouncing back). The losses and gains must be carefully balanced to optimize fuel efficiency and computer control can maintain the appropriate limits. This method is different than other mechanical methods tried which release the pressure of the unused cylinders and can be applied to all sequential fuel injection systems. The control must be customized for each automotive configuration. This refers to different control for a vehicle with different options such as a manual versus an automatic transmission or number of cylinders.

The second method MFI (modulated fuel injection) will certainly improve fuel economy when used during transition to a braking situation as mentioned in previously, along with other qualifying conditions. Table 1 shows an example of the modulation scheme for different engine rpm's, and is based on an eight-cylinder engine. Note that each pattern will end with an equal number of firings per engine revolution pattern to keep an equal load on all the cylinders. The optimum values for this table may change depending on the engine.

This method (MFI) is best if integrated into the vehicle with computer control to account for current load conditions. For instance if the vehicle speed was maintained above 60 MPH the aerodynamic drag may require that at least 4 effective cylinders be used. There are operating ranges for each particular load condition.

TABLE 1

| | | Number of | | |
|---|---|---|---|---|
| | | pattern, or | | |
| | | cycles to | Example of | |
| Effective | Modulation | repeat | Cylinder | RPM |
| #cylinders | Sequence | pattern | firing | Range |
| 0 (braking) | None | 1 | None | 1500 |
| | | | | on up |
| 4 (very light | [count 1, skip 1],1^{st} | 2 cycles | 1, 3, 5, 7, 2, | 2000 to |
| load) | [skip 1, count 1] 2^{nd} | | 4, 6, 8 | 2750 |
| | | | (full pattern) | |
| 5 1/3 | [count 2 skip 1] | 8 cycles | 1, 2, 4, 5, 7, | 1500 to |
| | | | 8, 2, 3, 5, | 3600 |
| | | | 6, 8, 1 . . . | |
| 6 2/5 | [count 4, skip 1] | 5 cycles | 1-4, 6-8, 1, | 1250 to |
| | | | 3-6 . . . | 4400 |
| 7 | [count 6, skip 1] | 7 cycles | 1-6, 8, 1- | 1150 to |
| | | | 5, 7, 8, 1 . . . | 4800 |

Discussion of Ramifications

Portions of this invention can apply to all engines such as using the AAR device to reduce acceleration. If a car without an electronic throttle sensor (such as carburetor) is to use this method it needs modification to the throttle control.

Also using fuel flow measurements to perform closed loop engine control will reduce fuel consumption and many combinations of the methods are possible. The vehicle user will determine the acceptable limits for increased mileage within a range limit. With computer control it is possible to automate the limits using fuzzy logic. One example of this would be selections such as low, medium and high mileage. Using less acceleration would mean a paradigm shift for the user. If fuel flow rate was used as feedback it would take even more of a shift depending on the limits. For example if attempting to use fuel flow as feedback driving in hilly conditions the peak rate would need to be higher. Also when going downhill it is possible to run on zero effective cylinders temporarily.

Also if there were one oxygen sensor per cylinder operation would be greatly simplified and more accurate.

I claim:

1. A process of transforming engine accelerator input to an output with limited vehicle acceleration at any point within the control limits consisting of:
(a) throttle conditioning unit which transforms the mechanical or electrical throttle response using vehicle velocity or velocity estimate as feedback.
(b) use fuel flow measurement and load conditions for engine fuel management either independently or combined with aforementioned method.

2. A method of improving fuel economy by disabling fuel injectors while monitoring engine parameters including:
(a) approximate equal distribution of engine load to all cylinders averaged over several engine cycles
(b) adaptively reducing the effective number of cylinders to minimize fuel consumption.
